(19) United States
(12) Patent Application Publication
(10) Pub. No.: US 2015/0226573 A1
(43) Pub. Date: Aug. 13, 2015

(54) PEDOMETER INTEGRATED PEDESTRIAN POSITIONING

(71) Applicant: QUALCOMM Incorporated, San Diego, CA (US)

(72) Inventors: Sameera PODURI, Sunnyvale, CA (US); Payam PAKZAD, Mountain View, CA (US); Yin CHEN, Campbell, CA (US)

(73) Assignee: QUALCOMM Incorporated, San Diego, CA (US)

(21) Appl. No.: 14/177,951

(22) Filed: Feb. 11, 2014

(51) Int. Cl. G01C 22/00

(52) U.S. Cl. CPC G01C 22/006

(57) ABSTRACT

An estimated position of a pedestrian is obtained by detecting, by a movement sensor on the pedestrian, whether the pedestrian is moving, propagating particles based on a predictive pedestrian movement model upon detecting that the pedestrian is moving, and updating, by a wireless network, the position of the pedestrian upon failure by the movement sensor to detect that the pedestrian is moving. The movement sensor may be a pedometer. The wireless network may be a local wireless network such as a Wi-Fi network.

### FIELD OF DISCLOSURE

Various embodiments described herein relate to positioning, and more particularly, to positioning of pedestrians.

### BACKGROUND

Various schemes have been devised for positioning of pedestrians by using satellite-based navigation systems such as the Global Positioning System (GPS) or the Global Navigation Satellite System (GNSS). In indoor environments, such as buildings or structures in which signals from navigation satellites are blocked or severely degraded due to attenuation or multipath effects, for example, local wireless positioning systems such as Wi-Fi based positioning systems have been utilized for the positioning of pedestrians. In typical Wi-Fi based positioning systems for pedestrian use, inertial sensors may be used to help the navigation system determine the pedestrian's motion.

In the absence of inertial sensors, typical Wi-Fi based pedestrian positioning systems may not be able to obtain direct observation of pedestrian motion, and instead may rely on predictive motion models for estimating the position of the pedestrian user. For example, a typical Wi-Fi based pedestrian positioning system may be implemented with a conventional predictive algorithm, which computes a predicted or estimated position of a pedestrian user at a future instant of time based on the time elapsed and a default motion model. As a consequence of this, when the user is static, the estimated position of the pedestrian user may continue to move, thereby resulting in large errors as the time elapses.

### SUMMARY

Exemplary embodiments of the invention are directed to apparatus and method for estimating the position of a pedestrian by using a movement sensor, for example, a pedometer, in combination with a wireless positioning system, for example, a Wi-Fi based positioning system, in an environment such as a structure or a building.

In an embodiment, a method of estimating a position of a pedestrian is provided, the method comprising: detecting, by a movement sensor on the pedestrian, whether the pedestrian is moving; propagating particles based on a predictive pedestrian movement model upon detecting that the pedestrian is moving; and updating, by a wireless network, the position of the pedestrian upon failure by the movement sensor to detect that the pedestrian is moving.

In another embodiment, an apparatus configured to perform operations to estimate a position of a pedestrian is provided, the apparatus comprising: a memory; and a processor for executing a set of instructions stored in the memory, the set of instructions comprising instructions for: detecting, by a movement sensor on the pedestrian, whether the pedestrian is moving; propagating particles based on a predictive pedestrian movement model upon detecting that the pedestrian is moving; and updating, by a wireless network, the position of the pedestrian upon failure by the movement sensor to detect that the pedestrian is moving.

In another embodiment, an apparatus configured to estimate a position of a pedestrian is provided, the apparatus comprising: means for detecting, by a movement sensor on the pedestrian, whether the pedestrian is moving; means for propagating particles based on a predictive pedestrian movement model upon detecting that the pedestrian is moving; and means for updating, by a wireless network, the position of the pedestrian upon failure by the movement sensor to detect that the pedestrian is moving.

In another embodiment, machine-readable storage medium encoded with instructions executable to perform operations to estimate a position of a pedestrian is provided, the operations comprising: detecting, by a movement sensor on the pedestrian, whether the pedestrian is moving; propagating particles based on a predictive pedestrian movement model upon detecting that the pedestrian is moving; and updating, by a wireless network, the position of the pedestrian upon failure by the movement sensor to detect that the pedestrian is moving.

Some exemplary embodiments of the invention are described below in the Detailed Description and illustrated by the drawings. The invention, however, is defined by the claims and is not limited by the exemplary embodiments described and illustrated.

### BRIEF DESCRIPTION OF THE DRAWINGS

The accompanying drawings are presented to aid in the description of embodiments of the invention and are provided solely for illustration of the embodiments and not limitations thereof.

FIG. 1 is a schematic diagram illustrating a position locating environment for a pedestrian in a building or enclosure utilizing a wireless network and a movement sensor such as a pedometer carried by the pedestrian in an embodiment according to the present invention.

FIG. 2 is a diagram illustrating an example of a typical floor plan of a commercial building in which the position locating environment of FIG. 1 is implemented.

FIG. 3 is a flowchart illustrating an embodiment of a method of estimating a position of a pedestrian according to the present invention.

FIG. 4 is a flowchart illustrating an embodiment in which particle propagation is based on a step length model for predicting pedestrian movement.

FIG. 5 is a diagram illustrating a typical distribution curve for particle propagation using a step length model.

FIG. 6 is a diagram illustrating a typical grid in which a particle representing a statistical sample of an estimated current position of the pedestrian is centered.

FIG. 7 is a flowchart illustrating an embodiment of propagating particles using a probabilistic distribution of step lengths in favor of continuing along the current direction of movement.

FIG. 8 is a flowchart illustrating an embodiment of propagating the particles using a probabilistic distribution of step lengths when movement by the pedestrian is confined by predetermined paths.

FIG. 9 is a flowchart illustrating an embodiment of updating the position of the pedestrian upon failure by the movement sensor to detect that the pedestrian is moving.

FIG. 10 is a flowchart illustrating another embodiment of updating the position of the pedestrian upon failure by the movement sensor to detect that the pedestrian is moving.

FIG. 11 is a flowchart illustrating an embodiment of updating the position of the pedestrian when the mobile device is able to obtain positioning data based on measurements from a plurality of wireless access points.

FIG. 12 is a flowchart illustrating another embodiment of updating the position of the pedestrian upon failure by the movement sensor to detect that the pedestrian is moving.

FIG. 13 is a diagram illustrating an example of tracing estimated positions of a pedestrian in comparison with the true path of the pedestrian in the commercial building as shown in FIG. 2.

FIG. 14 is a diagram illustrating an embodiment of an apparatus configured to perform operations to estimate the position of a pedestrian.

### DETAILED DESCRIPTION

Aspects of the invention are disclosed in the following description and related drawings directed to specific embodiments of the invention. Alternate embodiments may be devised without departing from the scope of the invention. Additionally, well known elements of the invention will not be described in detail or will be omitted so as not to obscure the relevant details of the invention.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a,” “an,” and “the,” are intended to include the plural forms as well, unless the context clearly indicates otherwise. It will be further understood that the terms “comprises,” “comprising,” “includes,” or “including,” when used herein, specify the presence of stated features, integers, steps, operations, elements, or components, but do not preclude the presence or addition of one or more other features, integers, steps, operations, elements, components, or groups thereof. Moreover, it is understood that the word “or” has the same meaning as the Boolean operator “OR,” that is, it encompasses the possibilities of “either” and “both” and is not limited to “exclusive or” (“XOR”), unless expressly stated otherwise.

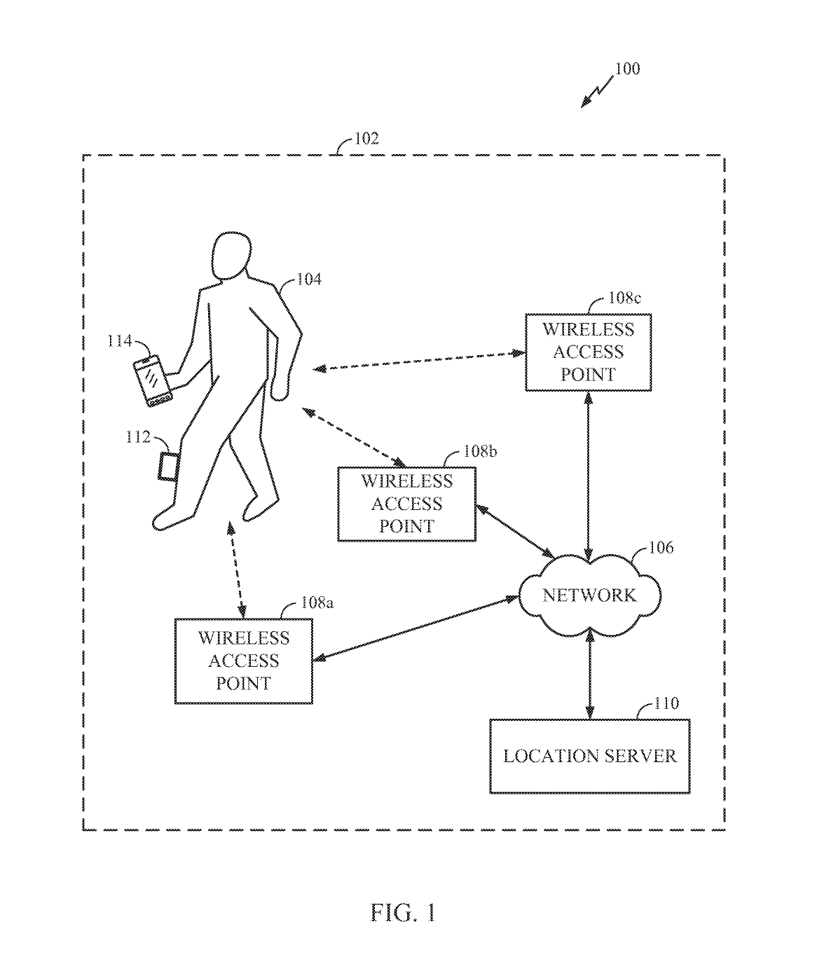

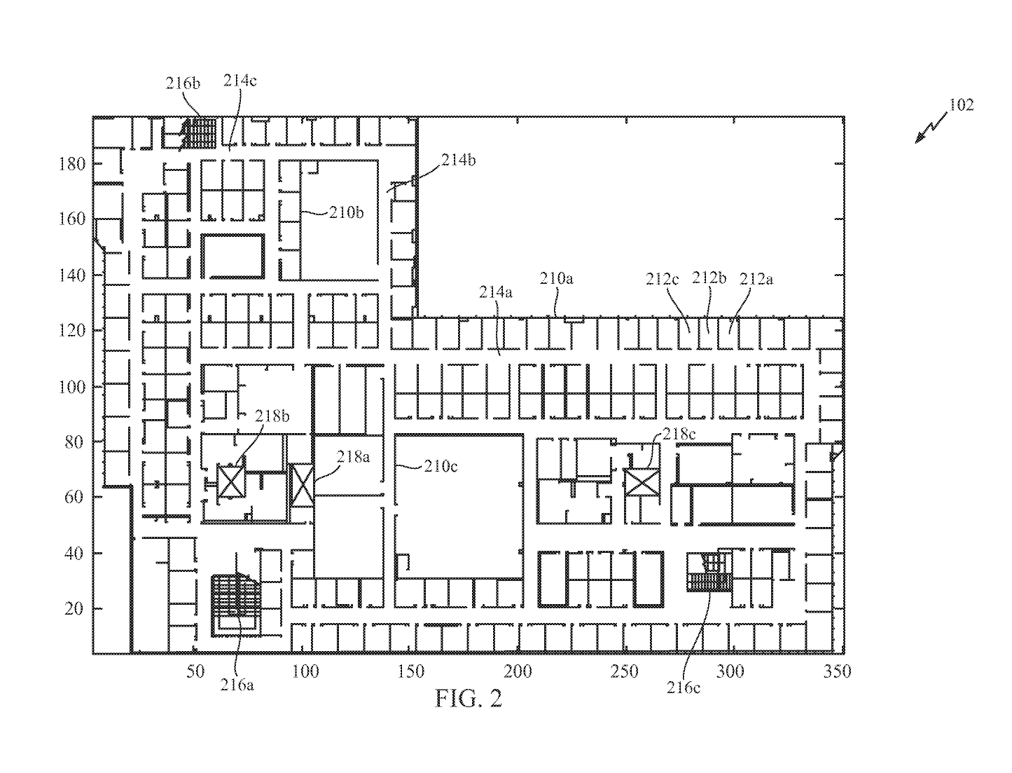

FIG. 1 is a schematic diagram illustrating a position locating environment 100 in a building 102. A pedestrian 104 may be moving or stationary in one of the rooms, hallways, stairways or elevators or confines of the building 102, an exemplary plan view of which is shown in FIG. 2 and described below. Referring to FIG. 1, reception of satellite navigation signals may be weak or nonexistent in some or all parts of the building 102. A local wireless network 106, for example, a Wi-Fi network, is provided within the building 102 to assist in the positioning of the pedestrian 104. In an embodiment, the local wireless network 106 is equipped with a plurality of wireless access points 108a, 108b and 108c within various locations of the building 102 to assist in the positioning of the pedestrian 104. In an embodiment, each of the wireless access points 108a, 108b and 108c may comprise a Wi-Fi access point, a Wi-Fi hot spot or a Wi-Fi handheld device. In an embodiment, the wireless network 106 may be connected to a location server 110 to assist in the positioning of the pedestrian 104.

In an embodiment, the pedestrian 104 is equipped with a movement sensor 112, such as a pedometer or another device that is capable of sensing movement of the pedestrian 104 by detecting the pedestrian's steps or strides when walking or running. In an embodiment, the pedestrian 104 is also equipped with a mobile device 114 which is capable of sending and receiving wireless signals to and from one or more of the wireless access points 108a, 108b and 108c of the wireless network 106 for positioning of the pedestrian 104. The movement sensor 112 may communicate with the wireless device 114 through wired or wireless connections, and the wireless device 114 may transmit sensor data from the movement sensor 112 to the wireless network 106 through one or more of the wireless access points 108a, 108b and 108c. Alternatively, if the movement sensor 112 is equipped with a wireless transmitter, such as a Wi-Fi transmitter, it may communicate directly with one or more of the wireless access points 108a, 108b and 108c.

FIG. 2 illustrates an example of a planar layout of a typical floor of a commercial building 102 with a plurality of walls or partitions, such as walls or partitions 210a, 210b, 210c, . . . dividing the floor into a plurality of rooms 212a, 212b, 212c, . . . and hallways 214a, 214b, 214c, . . . . Moreover, in such a typical commercial building 102, one or more stairways or escalators 216a, 216b and 216c and one or more elevators 218a, 218b and 218c may be provided. Although a plurality of wireless access points such as access points 108a, 108b and 108c as depicted in FIG. 1 may be strategically located in the building 102 to allow signal reception by the mobile device 114 carried by the pedestrian 104 regardless of where the pedestrian 104 is located, obstacles presented by walls or partitions 210a, 210b, 210c, . . . as depicted in FIG. 2 may result in undesirable attenuation or multipath fading of wireless signals. Thus, the wireless network 106 may not always provide accurate positioning data. Moreover, the movement sensor 112 such as a pedometer carried by the pedestrian 104 also may not always output accurate data to indicate that the pedestrian is moving or stationary.

In an embodiment, the movement sensor 112, such as a pedometer, is used in combination with a wireless positioning system provided by a wireless network 106, for example, a Wi-Fi assisted positioning system, to improve positioning performance and user experience. The pedometer, however, may not always reliably output pedometer data when the pedestrian 104 is moving. For example, the pedometer may wrongly indicate that the pedestrian 104 is not walking when in fact he is. As another example, a pedestrian 104 may be moving but not walking, and thus the pedometer would not be capable of detecting movement by the pedestrian 104. Examples of such scenarios include a person in a wheelchair, on a moving sidewalk, or on an escalator. Regardless of whether the pedestrian 104 is actually moving, the indoor positioning system may freeze and stop updating the pedestrian's positions until the pedometer recovers its function, that is, until the pedometer resumes outputting step events indicating that the pedestrian is moving.

Furthermore, in the absence of inertial sensors, a typical indoor positioning system such as one that relies on a wireless network 106, for example, a Wi-Fi network, does not have direct observation of the motion of the pedestrian 104. In the absence of direct observation of the pedestrian's motion, a default motion model may be used to predict the movement of the pedestrian 104. One example of such a default motion model is called a particle filter to model the movement of objects in two or three dimensions. In a particle filter model, a “particle,” which represents a statistical sample of a position of the pedestrian at a given time, may transition from an initial position to a subsequent position over a period of time in any one of an indefinite number of directions from the initial position. Possible transitions to particular subsequent positions may be modeled according to a probabilistic model conditioned on the initial position. For example, the likelihood that a particle may have a particular subsequent location, velocity and heading may be conditioned on an initial location, velocity and heading for that particular particle.

In an embodiment, the particle filter may be implemented as a software program in the mobile device 114 carried by the pedestrian 104. Alternatively, the particle filter may be implemented as a software program in the wireless network 106, in the location server 110, or in one or more of the wireless access points 108a, 108b and 108c. If the particle filter is implemented outside of the mobile device 114 carried by the pedestrian 104, the estimated locations, velocities or headings resulting from particle filtering may be transmitted from one or more of the wireless access points 108a, 108b and 108c to the mobile device 114, for example.

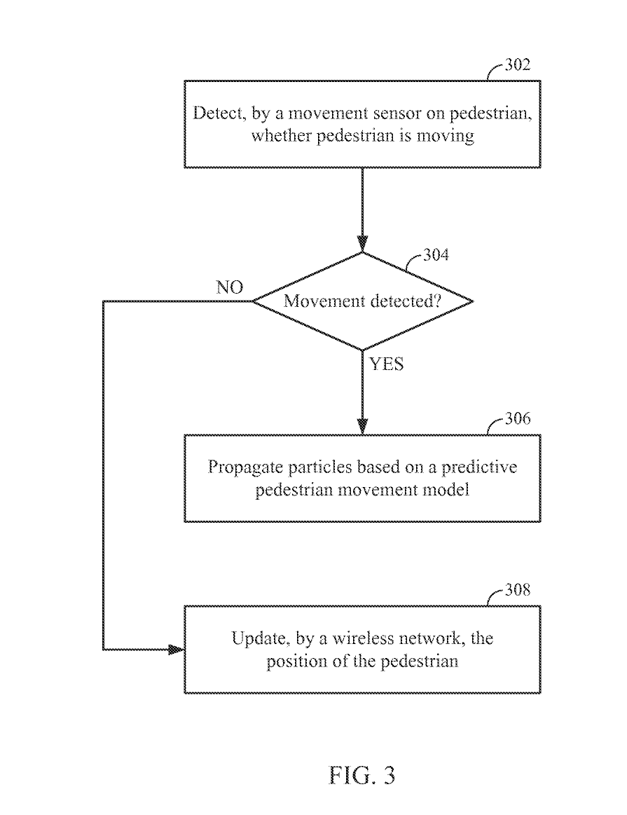

In embodiments according to the present invention, pedometer outputs are integrated into particle filters which include fallback modes in case the pedometer temporarily stops functioning or outputting pedometer data properly. FIG. 3 is a flowchart illustrating an embodiment of a method of estimating a position of a pedestrian according to the present invention. In FIG. 3, the method for estimating the position of a pedestrian includes the step of detecting, by the movement sensor, whether the pedestrian is moving as shown in block 302. Movement detection may be carried out by a movement sensor 112, such as a pedometer, carried by the pedestrian 104 as illustrated in FIG. 1. Referring to FIG. 3, if movement by the pedestrian is detected by the movement sensor in block 304, the particle filter propagates particles based on a predictive pedestrian movement model as shown in block 306. On the other hand, if the movement sensor fails to detect movement by the pedestrian in block 304 due to any of a variety of reasons, for example, mechanical or electrical failure of the movement sensor when the pedestrian is moving, or failure to detect movement when the pedestrian is moving but not walking or running, such as on a wheelchair, moving sidewalk or escalator, the estimated position of the pedestrian is updated by the wireless network as shown in block 308, without input from the movement sensor. It is understood that the failure of a movement sensor to detect movement by the pedestrian may but does not necessarily mean that the pedestrian is in fact stationary.

In an embodiment, the particle filter utilizes a particle motion model that is triggered by a pedometer event, that is, when the movement sensor 112 such as a pedometer detects a step movement by the pedestrian 104. Because in reality, a pedometer event is a probabilistic event considering that the pedometer may sometimes fail to output movement data when the pedestrian is moving, there is a threshold probability P, that is, the probability that the pedometer fails to output step events or otherwise erroneously indicates that the pedestrian is stationary even though the pedestrian is in fact moving. The threshold probability P may be predetermined and programmed into the particle filter. For example, the threshold probability P may be set at 0.2. In an embodiment, particle propagation is based on a predictive pedestrian movement model, such as a step length model.

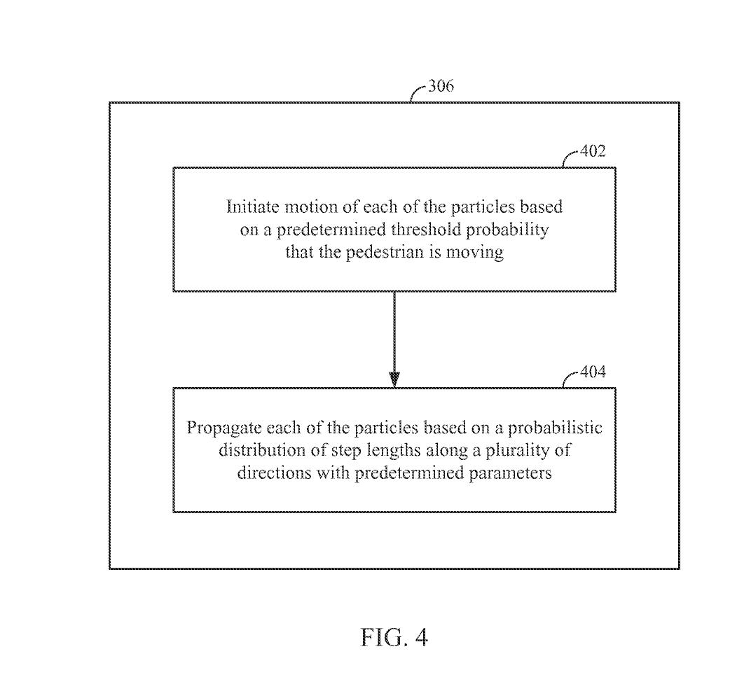

FIG. 4 is a flowchart illustrating an embodiment in which particle propagation is based on a step length model for predicting pedestrian movement. In the embodiment shown in FIG. 4, the step of propagating the particles as shown in block 306 comprises the steps of initiating motion of each of the particles based on a predetermined threshold probability that the pedestrian is moving, as shown in block 402, and propagating each of the particles based on a probabilistic distribution of step lengths along a plurality of directions with predetermined parameters, as shown in block 404. In an embodiment, the predetermined threshold probability P is set at 0.2.

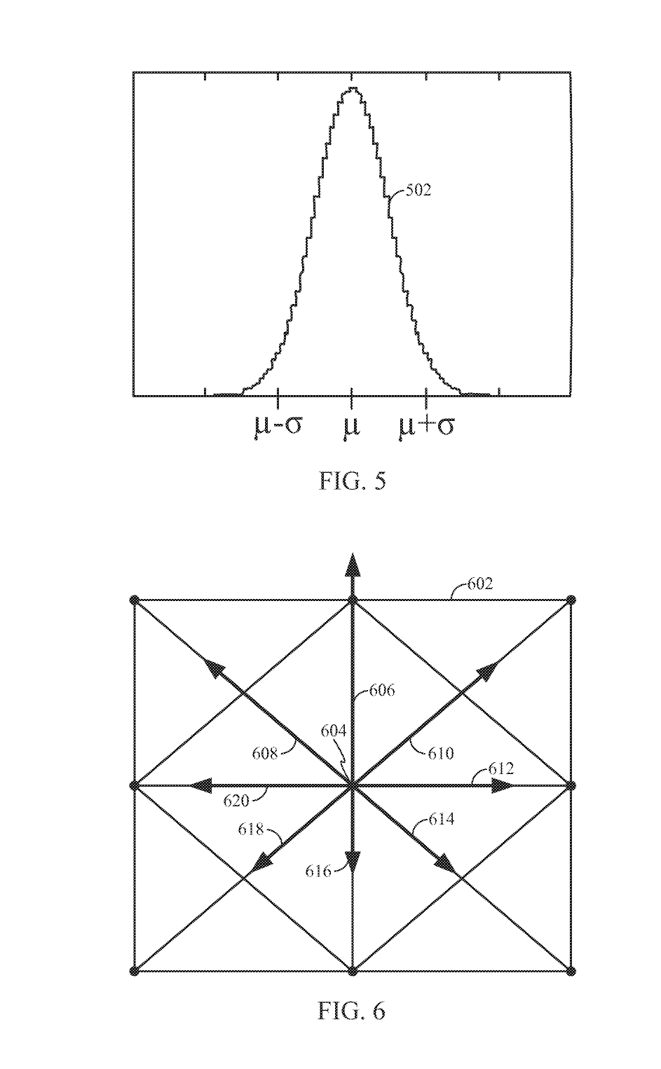

In a further embodiment, the probabilistic distribution of step lengths is a Gaussian distribution, and the predetermined parameters for such a Gaussian distribution include a mean (μ) approximately equal to an average distance of a walking step by the pedestrian. In yet a further embodiment, the predetermined parameters for the Gaussian distribution also include a standard deviation (μ) equal to approximately one-quarter (¼) of the average distance of a walking step. For example, if the average distance of a walking step by a typical adult pedestrian is about 2 feet (60 cm), the mean (μ) would be 2 feet (60 cm) while the standard deviation (σ) would be 0.5 foot (15 cm) if particle propagation is based on a step length model with Gaussian distribution. FIG. 5 illustrates a typical distribution curve 502 for particle propagation using a step length model, assuming that the particle filter receives no other data indicating the direction and velocity of movement, if any, by the pedestrian. The distribution curve 502 as shown in FIG. 5 has a mean (μ) approximately equal to the average distance of a walking step and a standard deviation (σ) approximately equal to one-quarter of the average distance of a walking step.

In an embodiment, if the pedestrian is moving along the edge of a wall or partition, or along a known hallway, then the probabilistic distribution of particle propagation may be skewed by taking into account the existence of such edge, wall or hallway. On the other hand, if there is no existing information about the direction of the pedestrian's movement, it may be assumed that the pedestrian may make an independent decision to turn in any direction at a given grid point. However, it may also be assumed that the pedestrian is more likely to continue along the current direction if no other information regarding his or her intended future direction is available, thus resulting in a skewed distribution in favor of continuation along the pedestrian's current direction. FIG. 6 shows a typical grid 602 in which a particle 604 representing a statistical sample of an estimated current position of the pedestrian is centered. Without other information indicating the pedestrian's future movement, it is assumed that he or she is more likely to continue moving along the current direction, as indicated by arrow 606. The pedestrian may also move in any other direction, for example, in any one of the directions indicated by arrows 608, 610, 612, 614, 616, 618 and 620, but with lower probabilities than the probability of moving along the current direction 606.

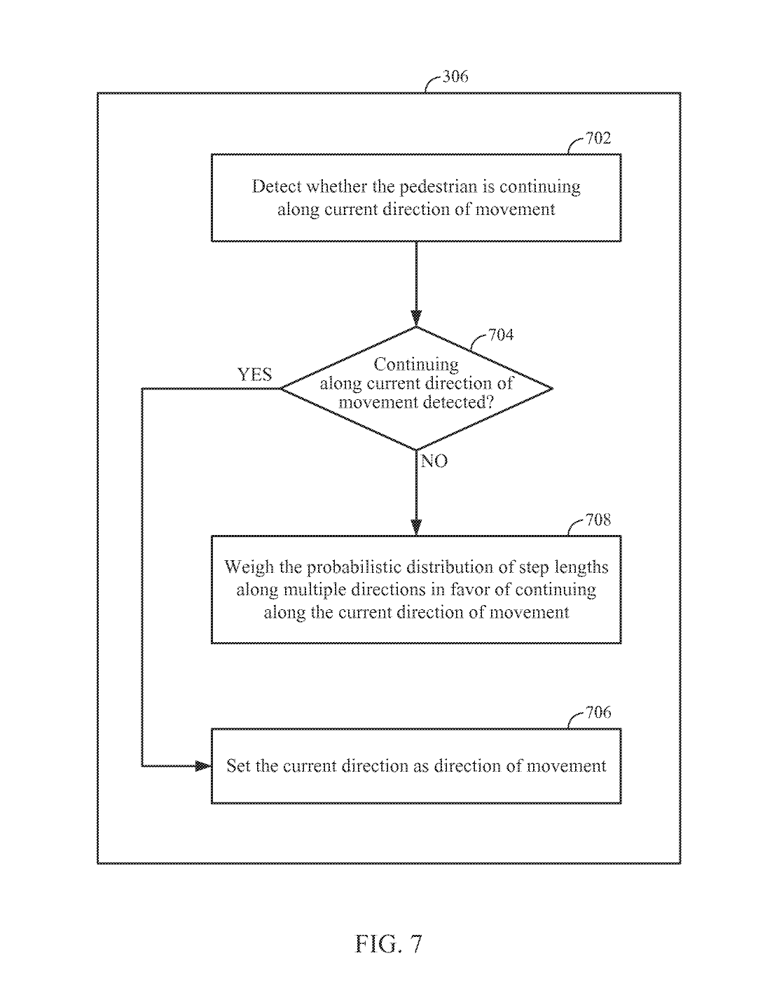

FIG. 7 is a flowchart illustrating an embodiment in which the step of propagating the particles as shown in block 306 includes the step of detecting whether the pedestrian is continuing along the current direction of movement, as shown in block 702. In an embodiment, the detection of whether the pedestrian is continuing along the current direction of movement may be achieved by the pedometer worn by the pedestrian. Alternatively, the wireless positioning system may detect whether the pedestrian is continuing along the current direction of movement. If a detection that the pedestrian is continuing along the current direction of movement is made in block 704, then the positioning system may set the current direction as the direction of movement as shown in block 706, and calculate the pedestrian's next estimated position accordingly. If no such detection is made in block 704, then the positioning system weights the probabilistic distributions of step lengths along multiple directions in favor of continuing along the current direction of movement, as shown in block 708. For example, FIG. 6, described above, shows the arrow 606 indicating continued movement in the pedestrian's current direction being longer than the arrows 608, 610, 612, 614, 616 and 618 in other directions, to illustrate skewed probabilistic distribution in favor of movement in the current direction.

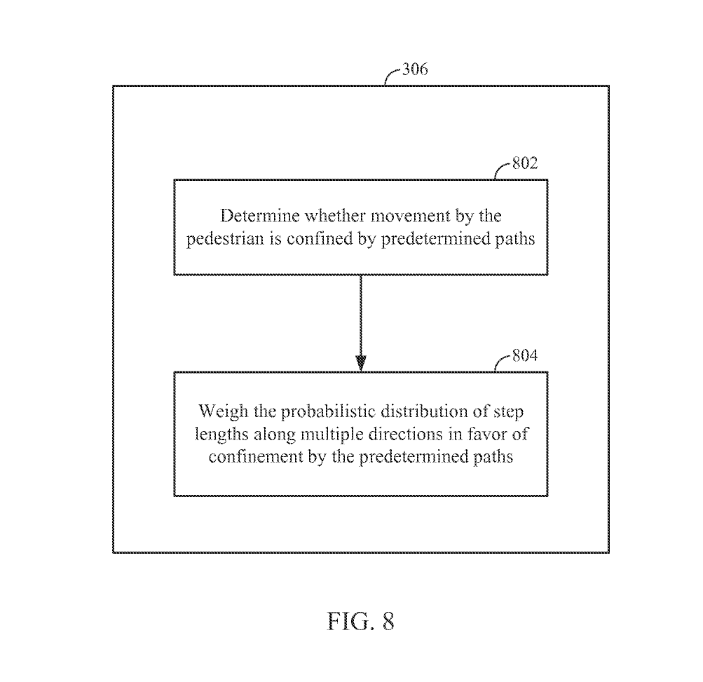

In an embodiment, if the pedestrian's movement is confined by predetermined paths in a building or structure, or by walls or partitions, the probabilistic distribution of step lengths along multiple directions may be skewed in favor of confinement by the predetermined paths even if no other information about the pedestrian's movement is available. FIG. 8 is a flowchart illustrating an embodiment in which the step of propagating the particles as shown in block 306 includes the steps of determining whether movement by the pedestrian is confined by predetermined paths, as shown in block 802, and weighting the probabilistic distribution of step lengths along multiple directions in favor of confinement by the predetermined paths, as shown in block 804. It is understood that although the pedestrian may be limited to walking along certain paths, for example, within known hallways, stairways or rooms in a building, the walking direction of the pedestrian still cannot be deterministically predicted if no measurement or sensor output is received by the positioning system. If the direction of the pedestrian's movement is detected, the pedestrian's next estimated position may be calculated with a higher degree of certainty.

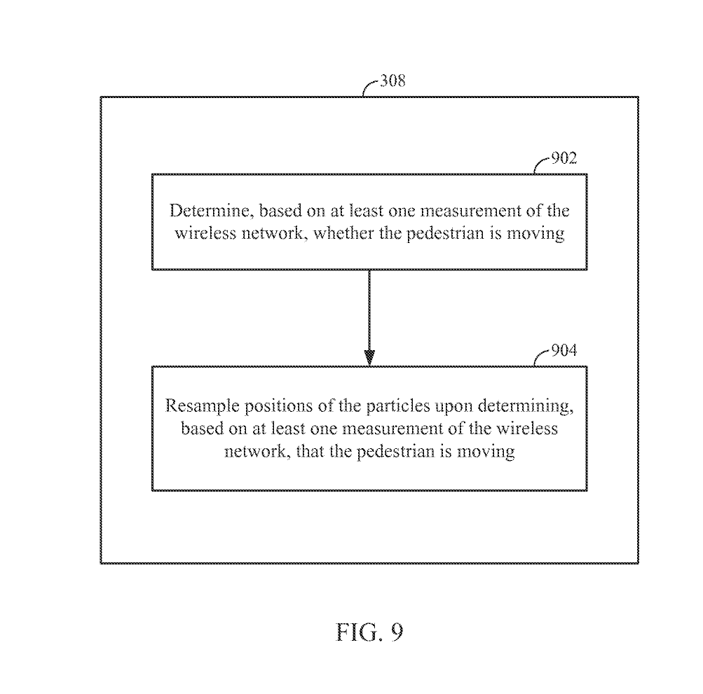

FIG. 9 is a flowchart illustrating an embodiment in which the step of updating, by a wireless network, the position of the pedestrian upon failure by the movement sensor to detect that the pedestrian is moving as shown in block 308 includes the steps of determining, based on at least one measurement of the wireless network, whether the pedestrian is moving, as shown in block 902, and resampling positions of the particles upon determining, based on at least one measurement of the wireless network, that the pedestrian is moving, as shown in block 904. In an embodiment in which the wireless network is a Wi-Fi network, for example, the measurement obtained by the wireless network may include a Wi-Fi measurement of the position of the pedestrian at a given time.

The position of the pedestrian may be repeatedly measured by the Wi-Fi positioning system in short intervals of time to determine whether the pedestrian has been static or has moved. For example, the Wi-Fi positioning system may measure the position of the pedestrian for a period of 2 seconds, and if it determines that the pedestrian's position has not been stationary in the last 2 seconds, thereby indicating that the pedestrian has moved, the particle filter may resample the particles based on the measurements of the pedestrian's positions obtained by the Wi-Fi positioning system in the last 2 seconds and update the pedestrian's current position accordingly. If, in the meantime, the movement sensor or pedometer carried by the pedestrian also outputs step events during this time interval, the current position of the pedestrian may be updated by taking into account both the Wi-Fi data from the Wi-Fi positioning system and the pedometer data from the pedometer.

On the other hand, if the movement sensor fails to detect movement by the pedestrian or fails to output data indicating that the pedestrian is moving, only the measurements obtained by the wireless network may be available for determining whether the pedestrian is moving. Thus, the positions of the particles in the particle filter may be resampled and updated to generate an estimated position of the pedestrian based only on the measurements from the wireless network, as illustrated in FIG. 9 and described above. In a further embodiment, if the wireless positioning system is able to measure the positions of a moving pedestrian in time intervals, even if the measurements are not taken nearly continuously and even if the pedometer fails to output sensor data indicating that the pedestrian is moving, a new position of the pedestrian may be calculated by weighted samples of one or more old positions of the pedestrian and a recently measured position of the pedestrian obtained by the wireless positioning system.

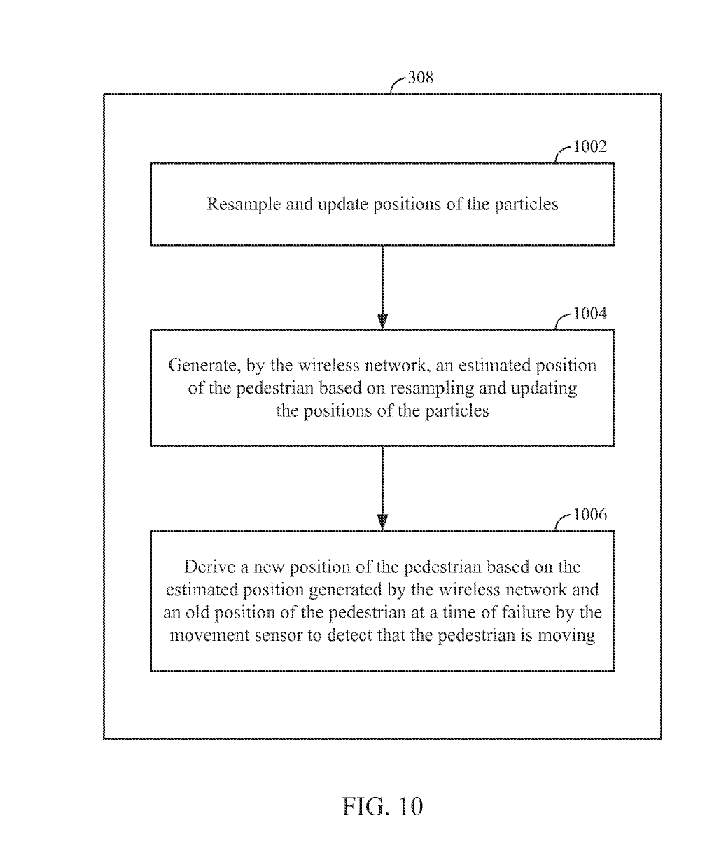

FIG. 10 is a flowchart illustrating an embodiment in which the step of updating, by a wireless network, the position of the pedestrian upon failure by the movement sensor to detect that the pedestrian is moving as shown in block 308 includes the steps of resampling and updating the positions of the particles, as shown in block 1002, generating, by the wireless network, an estimated position of the pedestrian based on resampling and updating the positions of the particles, as shown in block 1004, and deriving a new position of the pedestrian based on the estimated position generated by the wireless network and an old position of the pedestrian at a time of failure by the movement sensor to detect that the pedestrian is moving, as shown in block 1006. In an embodiment, during a period in which the movement sensor or pedometer is indicating that the pedestrian is stationary or is not outputting step events, resampling and updating of particle positions are based only on the positioning data measured by the Wi-Fi positioning system. In an embodiment, a new position of the pedestrian may be derived by weighted averaging of an old position and an estimated recent position based on measured Wi-Fi positioning data. In an embodiment, the new position of the pedestrian is computed as follows:

new_position=α*old_position+(1−α)*wifi_position (1)

where new_position is the computed new position of the pedestrian, old_position is an old position of the pedestrian, which may be a known starting point or a previously computed position of the pedestrian, wifi_position is an estimated recent position based on Wi-Fi measurements, and α is the weighting factor for the old position. In an embodiment, each particle, which represents a probabilistically sampled position of the pedestrian, may have its position updated by deriving its new position from weighted averaging of its old position and its recently estimated Wi-Fi position, according to equation (1) above. In an embodiment, the new position of the pedestrian is derived from a cluster of particles in their new positions based on weighted averaging of their respective old positions and recently estimated Wi-Fi positions.

In some scenarios, during a period in which the movement sensor or pedometer is not outputting any indication that the pedestrian is moving, repeated resampling and updating of particles to derive the new position of the pedestrian without particle propagation may result in the particle cloud clustering around or collapsing into one or a few particles. In an embodiment, in order to maintain particle diversity during a period in which the movement sensor or pedometer is not outputting an indication that the pedestrian is moving, fresh particles may be introduced, resampled and updated. For example, in each iteration of resampling and updating, a number of fresh particles equal to approximately 20% of existing particles may be introduced in proximity to the last known or estimated position of the pedestrian to maintain particle diversity. Moreover, during a period in which the movement sensor or pedometer is not outputting any indication of movement by the pedestrian, regardless of whether the pedestrian is in fact moving or not, the new position of the pedestrian may be heavily weighted in favor of maintaining the old position. For example, a predetermined weighting factor α of 0.9 may be assigned to equation (1) above, in favor of the old position.

In a typical indoor wireless positioning environment, a plurality of wireless access points such as wireless access points 108a, 108b and 108c as shown in FIG. 1 are provided at different locations to assist in the positioning of the pedestrian 104 equipped with a mobile device 114 as well as a movement sensor 112 such as a pedometer. In an embodiment, estimated positions of the pedestrian 104 may be refined based on measured positioning data from a plurality of such wireless access points 108a, 108b and 108c in communication with the mobile device 114.

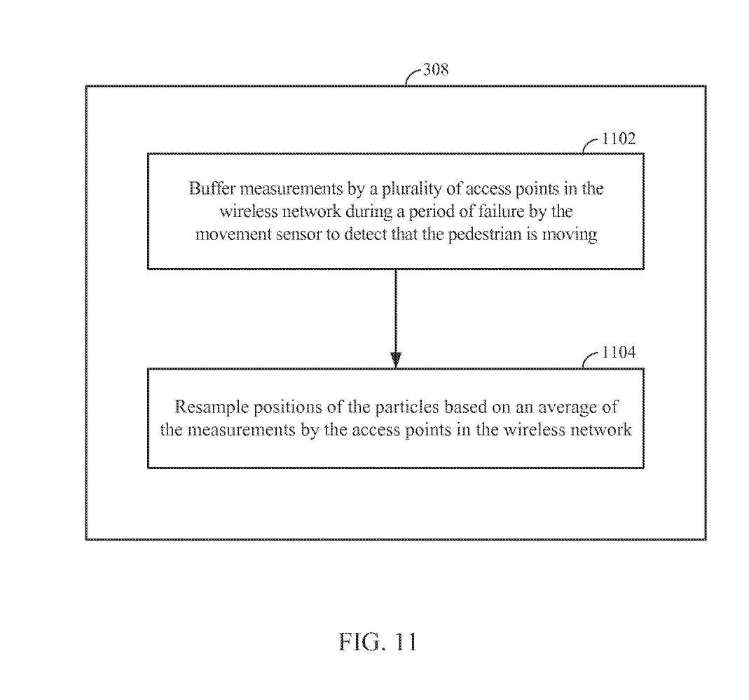

FIG. 11 is a flowchart illustrating an embodiment in which the pedestrian is able to obtain positioning data based on measurements from a plurality of wireless access points. In FIG. 11, the step of updating, by the wireless network, the position of the pedestrian upon failure by the movement sensor to detect that the pedestrian is moving, as shown in block 308, includes the steps of buffering measurements by a plurality of access points in the wireless network during a period of failure by the movement sensor to detect that the pedestrian is moving, as shown in block 1102, and resampling positions of the particles based on an average of the measurements by the access points in the wireless network, as shown in block 1104. In an embodiment, if it is unknown as to which of the access points generates “better” positioning data than others, the positioning data generated by the multiple access points may be weighted equally and averaged to obtain an estimated position of the pedestrian. In an embodiment, the position of each particle, representing a probabilistically sampled position of the pedestrian, may be resampled and updated based on averaging of positioning data from each of the wireless access points. In a further embodiment, fresh particles may be introduced to maintain particle diversity. For example, in each iteration of resampling, a number of fresh particles approximately equal to 20% of the existing particles may be introduced in proximity to the last known or estimated position of the pedestrian to maintain particle diversity.

In an alternate embodiment, the positions of the particles may be resampled based on a weighted average of measurements obtained by multiple access points in the wireless network, if it is known as to which of the access points in the wireless network provides better positioning data than others. For example, the mobile device 114 carried by the pedestrian 104 in FIG. 1 may be able to determine the strengths of wireless signals from the wireless access points 108a, 108b and 108c. For example, if the mobile device 114 determines that the strength of received signal from the first wireless access point 108a is stronger than the strength of received signal from the second wireless access point 108b, which is stronger than the strength of received signal from the third wireless access point 108c, then the wireless positioning data from the first access point 108a is accorded the most weight, whereas the wireless positioning data from the third access point 108c is accorded the least weight. A weighted average of positioning data received from the three access points 108a, 108b and 108c may be obtained and the positions of the particles resampled and updated according to the weighted average of positioning data from these access points.

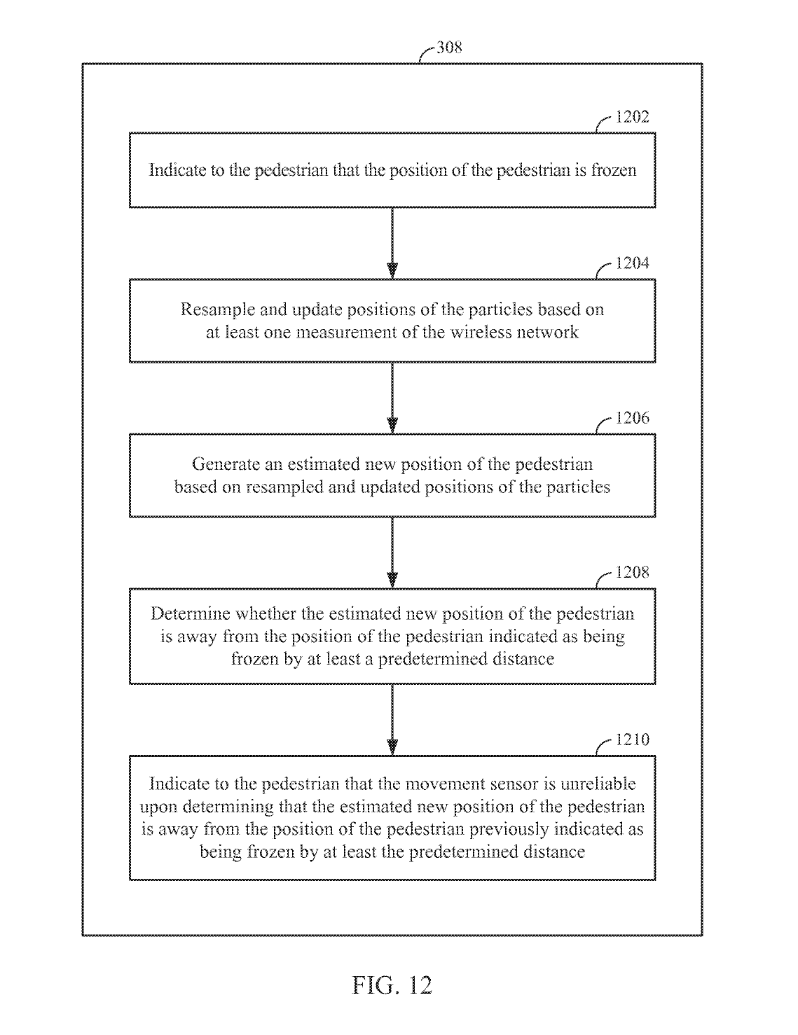

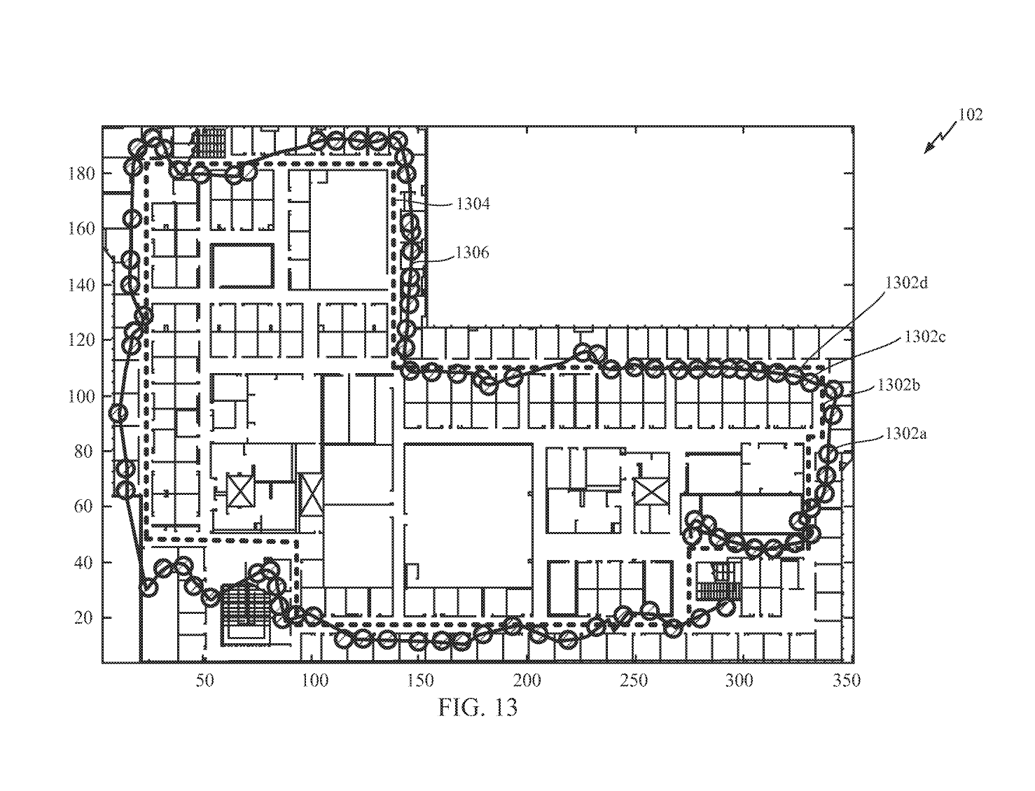

FIG. 12 is a flowchart illustrating another embodiment of updating the position of the pedestrian upon failure by the movement sensor to detect that the pedestrian is moving as shown in block 308. In FIG. 12, the step of updating the position of the pedestrian as shown in block 308 includes the step of indicating to the pedestrian that the position of the pedestrian is frozen, as shown in block 1202, if the movement sensor or pedometer stops outputting step events or fails to provide an indication that the pedestrian is moving. As a result of frozen position due to the failure of the movement sensor or pedometer to indicate movement by the pedestrian, the positions of the particles are resampled and updated based on at least one measurement of the wireless network as shown in block 1204. An estimated new position of the pedestrian is then generated based on the resampled and updated positions of the particles, which represent probabilistic samples of the pedestrian's position in the particle filter, as shown in block 1206. A determination is then made as to whether the estimated new position of the pedestrian based on positioning measurements from the wireless network is away from the position of the pedestrian last indicated as being frozen by at least a predetermined distance, as shown in block 1208. If the estimated new position of the pedestrian is far enough away from the last frozen position by at least the predetermined distance, then an indication is sent to the pedestrian that the movement sensor or pedometer is unreliable, as shown in block 1210.

An indication or warning may be sent to the pedestrian if the estimated new position resulting from the resampling and updating of particles based only on positioning data obtained from the wireless network when the movement sensor or pedometer fails to detect movement by the pedestrian is away from the last frozen position of the pedestrian by at least a relatively large predetermined distance, for example, about 20 feet (6 m). In an embodiment, the step of updating the position of the pedestrian further includes the steps of determining whether the movement sensor has resumed outputting movement signals, and indicating to the pedestrian that the movement sensor has recovered functioning upon determining that the movement sensor has resumed outputting movement signals.

In an embodiment, a flag may be set to indicate that the pedometer is not reliable if the estimated new position is away from the last frozen position of the pedestrian by at least the predetermined distance, and further positioning computations would be based only on measurements from the wireless network. In a further embodiment, after the flag is set indicating that the movement sensor or pedometer is unreliable, if the movement sensor or pedometer outputs new step events or signals indicating that the pedestrian is moving, then the flag is reset and the wireless positioning system resumes its mode of position estimation based on outputs from both the wireless network and the movement sensor or pedometer.

FIG. 13 is a diagram illustrating an example of tracing estimated positions of a pedestrian indicated by connected dots 1302a, 1302b, 1302c, 1302d, . . . in comparison with the true path 1304 of the pedestrian in the building 102, the floor plan view of which is shown in FIG. 2 and described above. Because the estimated positions of the pedestrian are based on probabilistic modeling of measured data from the wireless network, sometimes with and sometimes without the aid of output from a movement sensor such as a pedometer carried by the pedestrian, a path 1306 formed by connecting the estimated positions indicated by the dots, including dots 1302a, 1302b, 1302c, 1302d . . . , may not coincide exactly with the true path 1304 of the pedestrian. However, the estimated positions obtained from particle filtering may be close enough to the pedestrian's true positions for a satisfactory user experience.

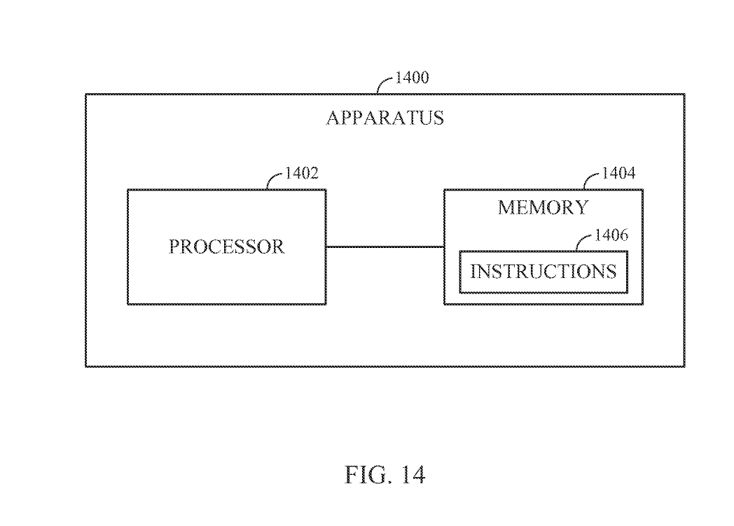

FIG. 14 is a block diagram illustrating an apparatus 1400 configured to perform operations to estimate the position of a pedestrian in an embodiment according to the present invention. In FIG. 14, the apparatus 1400 comprises a processor 1402 and a memory 1404 for storing a set of instructions 1406 executable by the processor 1402 to perform the process steps to obtain estimated positions of the pedestrian. In an embodiment, the processor 1402 executes the instructions 1406 stored in the memory 1404 for performing the process steps as described above, including, for example, the process steps as illustrated in one or more of the flowcharts of FIGS. 3, 4 and 7-12. Those of skill in the art will appreciate that the apparatus 1400 may be an integral part of a mobile device such as the mobile device 114 carried by the pedestrian 104 in FIG. 1. Those of skilled in the art will also appreciate that the apparatus 1400 may be implemented elsewhere, for example, in the movement sensor 112 as shown in FIG. 1. Moreover, those of skill in the art will also appreciate that the apparatus 1400 may be implemented in a device or system away from the pedestrian 104. For example, the apparatus 1400 may be provided in a network, such as the wireless network 106, a server such as the location server 110, or one or more wireless access points such as the wireless access points 108a, 108b and 108c in FIG. 1. If the apparatus 1400 for estimating the pedestrian's positions is implemented in a device or system away from the pedestrian 104, the estimated positions computed by the apparatus 1400 may be transmitted remotely to the mobile device 114 carried by the pedestrian 104 through one or more of the wireless access points 108a, 108b and 108c, for example.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the invention.

Furthermore, many embodiments are described in terms of sequences of actions to be performed by, for example, elements of a computing device. It will be recognized that various actions described herein can be performed by specific circuits, such as application specific integrated circuits (ASICs), by program instructions being executed by one or more processors, or by a combination of both. Additionally, these sequences of actions described herein can be considered to be embodied entirely within any form of computer readable storage medium having stored therein a corresponding set of computer instructions that upon execution would cause an associated processor to perform the functionality described herein. Thus, various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

The methods, sequences or algorithms described in connection with the embodiments disclosed herein may be embodied directly in hardware, in a software module executed by a processor, or in a combination of the two. A software module may reside in RAM, flash memory, ROM, EPROM, EEPROM, registers, a hard disk, a removable disk, a CD-ROM, or any other form of storage medium known in the art. An exemplary storage medium is coupled to the processor such that the processor can read information from, and write information to, the storage medium. In an alternative, the storage medium may be integral to the processor.

Accordingly, an embodiment of the invention can include a computer readable medium embodying a method of estimating a position of a pedestrian. Accordingly, the invention is not limited to illustrated examples and any means for performing the functionality described herein are included in embodiments of the invention.

While the foregoing disclosure describes illustrative embodiments of the invention, it should be noted that various changes and modifications could be made herein without departing from the scope of the invention as defined by the appended claims. The functions, steps or actions in the method and apparatus claims in accordance with the embodiments of the invention described herein need not be performed in any particular order unless explicitly stated otherwise. Furthermore, although elements of the invention may be described or claimed in the singular, the plural is contemplated unless limitation to the singular is explicitly stated.

What is claimed is:

1. A method of estimating a position of a pedestrian, comprising:
detecting, by a movement sensor on the pedestrian, whether the pedestrian is moving;
propagating particles representing statistical samples of the position of the pedestrian at a given time based on a predictive pedestrian movement model upon detecting that the pedestrian is moving; and
updating, by a wireless network, the position of the pedestrian upon failure by the movement sensor to detect that the pedestrian is moving.

2. The method of claim 1, wherein the movement sensor comprises a pedometer.

3. The method of claim 2, wherein the step of detecting, by a movement sensor on the pedestrian, whether the pedestrian is moving comprises the step of detecting, by the pedometer, one or more step events of the pedestrian.

4. The method of claim 3, wherein the predictive pedestrian movement model comprises a step length model.

5. The method of claim 4, wherein the step of propagating particles comprises the steps of:
initiating motion of each of the particles based on a predetermined threshold probability that the pedestrian is moving; and
propagating each of the particles based on a probabilistic distribution of step lengths along a plurality of directions with predetermined parameters.

6. The method of claim 5, wherein the probabilistic distribution of step lengths comprises a Gaussian distribution, and wherein the predetermined parameters comprise a mean approximately equal to an average distance of a walking step by the pedestrian.

7. The method of claim 6, wherein the predetermined parameters further comprise a standard deviation approximately equal to one quarter of the mean.

8. The method of claim 5, wherein the step of propagating the particles comprises the steps of:
detecting whether the pedestrian is continuing along a current direction of movement; and
weighting the probabilistic distribution of step lengths along the plurality of directions in favor of continuing along the current direction of movement upon failure to detect that the pedestrian is continuing along the current direction of movement.

9. The method of claim 5, wherein the step of propagating the particles comprises the steps of:
determining whether movement by the pedestrian is confined by one or more predetermined paths; and
weighting the probabilistic distribution of step lengths along the plurality of directions in favor of confinement by said one or more predetermined paths.

10. The method of claim 1, wherein the wireless network comprises a Wi-Fi network.

11. The method of claim 1, wherein the step of updating, by a wireless network, the position of the pedestrian upon failure by the movement sensor to detect that the pedestrian is moving comprises the steps of:
determining, based on at least one measurement of the wireless network, whether the pedestrian is moving; and
resampling positions of the particles upon determining, based on said at least one measurement of the wireless network, that the pedestrian is moving.

12. The method of claim 1, wherein the step of updating, by a wireless network, the position of the pedestrian upon failure by the movement sensor to detect that the pedestrian is moving comprises the steps of:
resampling and updating positions of the particles;
generating, by the wireless network, an estimated position of the pedestrian based on resampling and updating the positions of the particles; and
deriving a new position of the pedestrian based on the estimated position generated by the wireless network and an old position of the pedestrian at a time of failure by the movement sensor to detect that the pedestrian is moving.

13. The method of claim 12, wherein the step of deriving a new position of the pedestrian comprises the step of weighting the old position of the pedestrian and the estimated position generated by the wireless network by a predetermined weighting factor.

14. The method of claim 1, wherein the wireless network comprises a plurality of access points, and wherein the step of updating, by a wireless network, the position of the pedestrian upon failure by the movement sensor to detect that the pedestrian is moving comprises the steps of:
buffering measurements by the plurality of access points in the wireless network during a period of failure by the movement sensor to detect that the pedestrian is moving; and
resampling positions of the particles based on an average of the measurements by the plurality of access points in the wireless network.

15. The method of claim 14, wherein the step of resampling positions of the particles comprises the step of resampling positions of the particles based on a weighted average of the measurements by the plurality of access points in the wireless network.

16. The method of claim 1, wherein the step of updating, by a wireless network, the position of the pedestrian upon failure by the movement sensor to detect that the pedestrian is moving comprises the steps of:
indicating to the pedestrian that the position of the pedestrian is frozen;
resampling and updating positions of the particles based on at least one measurement of the wireless network;
generating an estimated new position of the pedestrian based on resampled and updated positions of the particles;
determining whether the estimated new position of the pedestrian is away from the position of the pedestrian indicated as being frozen by at least a predetermined distance; and
indicating to the pedestrian that the movement sensor is unreliable upon determining that the estimated new position of the pedestrian is away from the position of the pedestrian indicated as being frozen by at least the predetermined distance.

17. The method of claim 16, wherein the step of updating, by a wireless network, the position of the pedestrian upon failure by the movement sensor to detect that the pedestrian is moving further comprises the steps of:
determining whether the movement sensor has resumed outputting movement signals; and
indicating to the pedestrian that the movement sensor has recovered functioning upon determining that the movement sensor has resumed outputting movement signals.

18. An apparatus configured to perform operations to estimate a position of a pedestrian, the apparatus comprising:
a memory; and
a processor for executing a set of instructions stored in the memory, the set of instructions comprising instructions for:
detecting, by a movement sensor on the pedestrian, whether the pedestrian is moving;
propagating particles representing statistical samples of the position of the pedestrian at a given time based on a predictive pedestrian movement model upon detecting that the pedestrian is moving; and
updating, by a wireless network, the position of the pedestrian upon failure by the movement sensor to detect that the pedestrian is moving.

19. The apparatus of claim 18, wherein the instruction for updating, by a wireless network, the position of the pedestrian upon failure by the movement sensor to detect that the pedestrian is moving comprises instructions for:
determining, based on at least one measurement of the wireless network, whether the pedestrian is moving; and
resampling positions of the particles upon determining, based on said at least one measurement of the wireless network, that the pedestrian is moving.

20. The apparatus of claim 18, wherein the instruction for updating, by a wireless network, the position of the pedestrian upon failure by the movement sensor to detect that the pedestrian is moving comprises instructions for:
resampling and updating positions of the particles;
generating, by the wireless network, an estimated position of the pedestrian based on resampling and updating the positions of the particles; and
deriving a new position of the pedestrian based on the estimated position generated by the wireless network and an old position of the pedestrian at a time of failure by the movement sensor to detect that the pedestrian is moving.

21. The apparatus of claim 18, wherein the wireless network comprises a plurality of access points, and wherein the instruction for updating, by a wireless network, the position of the pedestrian upon failure by the movement sensor to detect that the pedestrian is moving comprises instructions for:
buffering measurements by the plurality of access points in the wireless network during a period of failure by the movement sensor to detect that the pedestrian is moving; and
resampling positions of the particles based on an average of the measurements by the plurality of access points in the wireless network.

22. The apparatus of claim 18, wherein the instruction for updating, by a wireless network, the position of the pedestrian upon failure by the movement sensor to detect that the pedestrian is moving comprises instructions for:
indicating to the pedestrian that the position of the pedestrian is frozen;
resampling and updating positions of the particles based on at least one measurement of the wireless network;
generating an estimated new position of the pedestrian based on resampled and updated positions of the particles;
determining whether the estimated new position of the pedestrian is away from the position of the pedestrian indicated as being frozen by at least a predetermined distance; and
indicating to the pedestrian that the movement sensor is unreliable upon determining that the estimated new position of the pedestrian is away from the position of the pedestrian indicated as being frozen by at least the predetermined distance.

23. An apparatus configured to estimate a position of a pedestrian, the apparatus comprising:
means for detecting, by a movement sensor on the pedestrian, whether the pedestrian is moving;
means for propagating particles representing statistical samples of the position of the pedestrian at a given time based on a predictive pedestrian movement model upon detecting that the pedestrian is moving; and
means for updating, by a wireless network, the position of the pedestrian upon failure by the movement sensor to detect that the pedestrian is moving.

24. The apparatus of claim 23, wherein the means for updating, by a wireless network, the position of the pedestrian upon failure by the movement sensor to detect that the pedestrian is moving comprises:
means for determining, based on at least one measurement of the wireless network, whether the pedestrian is moving; and
means for resampling positions of the particles upon determining, based on said at least one measurement of the wireless network, that the pedestrian is moving.

25. The apparatus of claim 23, wherein the means for updating, by a wireless network, the position of the pedestrian upon failure by the movement sensor to detect that the pedestrian is moving comprises:
means for resampling and updating positions of the particles;
means for generating, by the wireless network, an estimated position of the pedestrian based on resampling and updating the positions of the particles; and
means for deriving a new position of the pedestrian based on the estimated position generated by the wireless network and an old position of the pedestrian at a time of failure by the movement sensor to detect that the pedestrian is moving.

26. The apparatus of claim 23, wherein the wireless network comprises a plurality of access points, and wherein the means for updating, by a wireless network, the position of the pedestrian upon failure by the movement sensor to detect that the pedestrian is moving comprises:
means for buffering measurements by the plurality of access points in the wireless network during a period of failure by the movement sensor to detect that the pedestrian is moving; and
means for resampling positions of the particles based on an average of the measurements by the plurality of access points in the wireless network.

27. A machine-readable storage medium encoded with instructions executable to perform operations to estimate a position of a pedestrian, the operations comprising:
detecting, by a movement sensor on the pedestrian, whether the pedestrian is moving;
propagating particles representing statistical samples of the position of the pedestrian at a given time based on a predictive pedestrian movement model upon detecting that the pedestrian is moving; and
updating, by a wireless network, the position of the pedestrian upon failure by the movement sensor to detect that the pedestrian is moving.

28. The machine-readable storage medium of claim 27, wherein the operation of updating, by a wireless network, the position of the pedestrian upon failure by the movement sensor to detect that the pedestrian is moving comprises:
determining, based on at least one measurement of the wireless network, whether the pedestrian is moving; and
resampling positions of the particles upon determining, based on said at least one measurement of the wireless network, that the pedestrian is moving.

29. The machine-readable storage medium of claim 27, wherein the operation of updating, by a wireless network, the position of the pedestrian upon failure by the movement sensor to detect that the pedestrian is moving comprises:
resampling and updating positions of the particles;
generating, by the wireless network, an estimated position of the pedestrian based on resampling and updating the positions of the particles; and
deriving a new position of the pedestrian based on the estimated position generated by the wireless network and an old position of the pedestrian at a time of failure by the movement sensor to detect that the pedestrian is moving.

30. The machine-readable storage medium of claim 27, wherein the wireless network comprises a plurality of access points, and wherein the operation of updating, by a wireless network, the position of the pedestrian upon failure by the movement sensor to detect that the pedestrian is moving comprises:
buffering measurements by the plurality of access points in the wireless network during a period of failure by the movement sensor to detect that the pedestrian is moving; and
resampling positions of the particles based on an average of the measurements by the plurality of access points in the wireless network.
